(19) United States
(12) Patent Application Publication
(10) Pub. No.: US 2025/0213330 A1
(43) Pub. Date: Jul. 3, 2025

(54) Lingual Bracket

(71) Applicants: Qifeng CHEN, Ningde City (CN); Jialiang CHEN, Ningde City (CN)

(72) Inventors: Qifeng CHEN, Ningde City (CN); Jialiang CHEN, Ningde City (CN)

(21) Appl. No.: 19/086,027

(22) Filed: Mar. 20, 2025

Related U.S. Application Data
(63) Continuation-in-part of application No. PCT/CN2023/116971, filed on Sep. 5, 2023.

(30) Foreign Application Priority Data
Sep. 21, 2022 (CN) 202222505938.1

(51) Int. Cl. A61C 7/14

(52) U.S. Cl. CPC A61C 7/145; A61C 7/141; A61C 7/143

(57) ABSTRACT

A lingual bracket includes a bracket base (1), a bracket wing (2), and a spring (3), the bracket base (1) has an upper surface with an end provided with a fixed wing (11) and the other end provided with an auxiliary tube (12), and a bottom face provided with a non-skid bonding face (13); the bracket wing (2) has an insertion leg (21) and a wing portion (22), and can be positioned on the fixed wing (11) by the spring (3) sleeved on the insertion leg (21); a longitudinal groove (111) is provided along a central axis of the fixed wing (11) of the bracket base (1), and a transverse groove (112) is provided at a rear end face of the fixed wing (11); and the insertion leg of the bracket wing (2) has the width equivalent to that of the longitudinal groove (111), and can be placed in the longitudinal groove (111), a joint of the insertion leg (21) and the wing portion (22) is provided with a wide extension part (23), and when the insertion leg (21) is placed in the longitudinal groove (111) and pushed forward by the spring (3), the wide extension portion (23) can be interposed into the transverse groove (112) to form a positioning structure. The two crisscrossed grooves in the bracket base (1) are utilized to form the constraint for the bracket wing (2), enabling the features of an ingenious design, a simple structure, easy machining, and a convenient clinical operation.

### RELATED APPLICATIONS

This application is a continuation-in-part (CIP) application claiming benefit of PCT/CN2023/116971 filed on Sep. 5, 2023, which claims priority to Chinese Utility Model application Ser. No. 20/222,2505938.1 filed on Sep. 21, 2022, the disclosures of which are incorporated herein in their entirety by reference.

### FIELD OF THE INVENTION

The present invention relates to the field of dental orthodontics, and in particular to a lingual bracket, especially a solution in which positioning is made by pre-tension of a spring and sustaining orthodontic force is generated by the spring.

### DESCRIPTION OF THE PRIOR ART

The prior patent CN201010262798.9 discloses a lingual bracket, including a bracket body and a movable wing, characterized in that the bracket body consists of a bracket base whose lower surface is provide with a non-skid pattern and a fixed wing which is integrally protruded at an end of the bracket base, a through hole being provided along a central axis of the fixed wing; the movable wing has an end with an arch wire hook and the other end with a fixed portion; and the section where an end of the fixed portion of the movable wing passes through the through hole in the fixed wing is sleeved with a spring, an end of which abuts against the fixed wing, and the other end of which is positioned at the fixed portion of the movable wing. In the structure, only after the fixed portion of the movable wing passes through the through hole, the spring can be loaded to form an abutting relationship, and the fixed portions of other structures, except for the solution of its outward bending, enable relatively cumbersome operations clinically; and, the solution of the fixed portion's outward bending is also limited by the material of the bracket, and clinically, the drawback of breaking often occurs during bending.

How to provide a solution of an easily assembled bracket to overcome the shortcomings of the prior art becomes the research subject of the present invention.

### SUMMARY OF THE INVENTION

The purpose of the present invention is to design a lingual bracket in which a bracket wing is constrained by a bracket base in cooperation with a spring by longitudinal and transverse grooves perpendicular to each other.

The technical solution of the present invention is implemented as follows: a lingual bracket, comprising a bracket base, a bracket wing, and a spring, the bracket base having an upper surface with an end provided with a fixed wing and the other end provided with an auxiliary tube, and a bottom face provided with a non-skid bonding face; and the bracket wing having an insertion leg and a wing portion, and capable of being positioned on the fixed wing by the spring sleeved on the insertion leg; characterized in that: a longitudinal groove is provided along a central axis of the fixed wing of the bracket base, and a transverse groove is provided at a rear end face of the fixed wing; and the insertion leg of the bracket wing has the width equivalent to that of the longitudinal groove, and is capable of being placed in the longitudinal groove, a joint of the insertion leg and the wing portion is provided with a wide extension part, and when the insertion leg is placed in the longitudinal groove and pushed forward by the spring, the wide extension portion is capable of being interposed into the transverse groove to form a positioning structure.

The upper surface of the bracket base forms a first arc face between the auxiliary tube and the fixed wing, at least a lower surface of the transverse groove of the fixed wing forms a second arc face, and the first arc face and the second arc face share a same center point; the bonding face of the bracket base is biased at an end of the auxiliary tube, and forms a raised arc at an end of the fixed wing; and a mating face of the bracket wing mated with the bracket base also forms an arc face structure that, upon assembling in place, has the same center point as the first arc face.

The second arc face of the surface of the bracket base has a radius smaller than that of the first arc face and the radius of the second arc face is at least one wire diameter of the spring smaller than that of the first arc face.

The fixed wing of the bracket base has an arched top and is provided with, in a facing-forward mode, a tying wing; and the wing portion of the bracket wing is provided with, in a facing-forward mode, a cap mated with the arched top, and is provided with, in a facing-downward mode, a tying hook.

A square-corner slot accommodating an arch wire is provided between the cap of the bracket wing and the wide extension portion.

The bracket wing is machined to have an arch wire slot at a rear side of the cap, and the arch wire slot has front and rear slot faces which are arc faces centered on the auxiliary tube.

The present invention ingeniously utilizes two crisscrossed grooves in the bracket base to from the constrain for the bracket wing, and leads to a simplified assembling process in which only placement after compressing a spring is required, and continuous orthodontic force can also be generated by means of spring force; and the present invention has the features of an ingenious design, a simple structure, easy machining, and a convenient clinical operation.

### BRIEF DESCRIPTION OF THE DRAWINGS

The present invention is further described below in combination with specific drawings:

FIG. 1 is a schematic view of a lingual bracket;

FIG. 2 is a schematic exploded view of a lingual bracket;

FIG. 3 is a schematic side view of a lingual bracket; and

FIG. 4 is a schematic side view of a lingual bracket II.

In which:
1—bracket base; 11—fixed wing; 111—longitudinal groove; 112—transverse groove
12—auxiliary tube; 13—bonding face; 14—first arc face; 15—second arc face
16—tying wing; 2—bracket wing; 21—insertion leg; 22—wing portion
221—cap; 222—tying hook; 223—square-corner slot; 224—arch wire slot
23—wide extension portion; 24—T-shape head; 3—spring

### DETAILED DESCRIPTION OF THE PREFERRED EMBODIMENTS

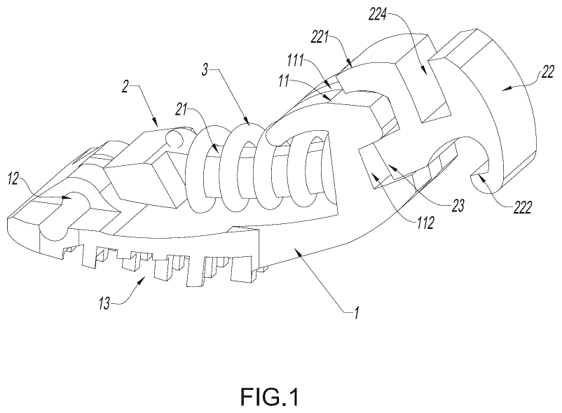

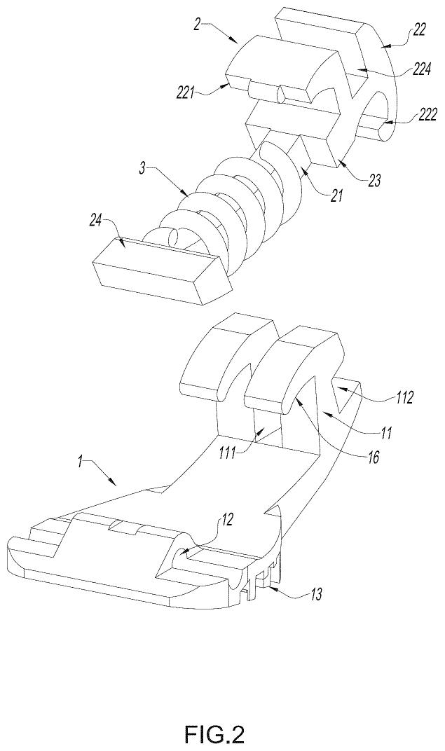

Referring to FIGS. 1, 2 and 3, a lingual bracket includes a bracket base 1, a bracket wing 2, and a spring 3; the bracket base 1 has an upper surface with an end provided with a fixed wing 11 and the other end provided with an auxiliary tube 12, and a bottom face provided with a non-skid bonding face 13; a longitudinal groove 111 is provided along a central axis of the fixed wing 11, and a transverse groove 112 is provided at a rear end face of the fixed wing, the transverse groove 112 and the longitudinal groove 111 form a perpendicular structure and are both open structures, facilitating to assemble the bracket wing 2 via placement.

The bracket wing 2 has an insertion leg 21 and a wing portion 22, and the insertion leg 21 has the width equivalent to that of the longitudinal groove 111, and can be placed in the longitudinal groove 111; and a joint of the insertion leg 21 and the wing portion 22 is provided with a wide extension part 23, and the free end of the insertion leg 21 has a T-shape head 24. The spring 3 is sleeved on the insertion leg 21, and when the spring 3 is assembled in place, one end of the spring 3 abuts against the T-shape head 24, and the other end of the spring 3 abuts against the fixed wing 11. The spring 3 can be put outside the insertion leg 21 via rotation through a wire gap, when the bracket wing is assembled, the insertion leg 21 is placed in the longitudinal groove 111 after the spring 3 is compressed, and abuts against the fixed wing 11 when the spring 3 is released, the wide extension portion 23 can be interposed into the transverse groove 112 by being pushed forward by the spring, and by means of the in-place interlocking of the wide extension portion 23 with the transverse groove 112, the axis inclination of a tooth can be effectively controlled.

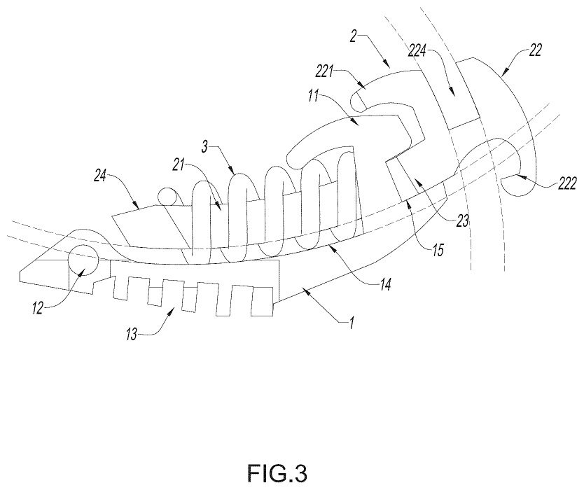

As shown in FIG. 3, furthermore, the upper surface of the bracket base 1 forms a first arc face 14 between the auxiliary tube and the fixed wing, at least a lower surface of the transverse groove of the fixed wing forms a second arc face 15, and the first arc face 14 and the second arc face 15 have a same center point; and the bonding face 13 of the bracket base is biased at an end of the auxiliary tube 12, and forms a raised arc at an end of the fixed wing 11 to generate a clearance space for a tooth neck.

A mating face of the bracket wing 2 mated with the bracket base 1 also forms an arc face structure that, upon assembling in place, has a same center point as the first arc face 14. Specifically, the mating face referred here is the lower surface of the bracket wing 2, which is allowed to closely fit to the second arc face 15 of the bracket base, and is suitable for a feeding process for orthodontic.

Additionally, the second arc face 15 of the surface of the bracket base 1 has a radius smaller than that of the first arc face 14 and the radius of the second arc face 15 is at least one wire diameter of the spring 3 smaller than that of the first arc face, to generate a clearance space for assembling a spring. In addition to a cylindrical spring, the spring 3 may be a rectangular spring.

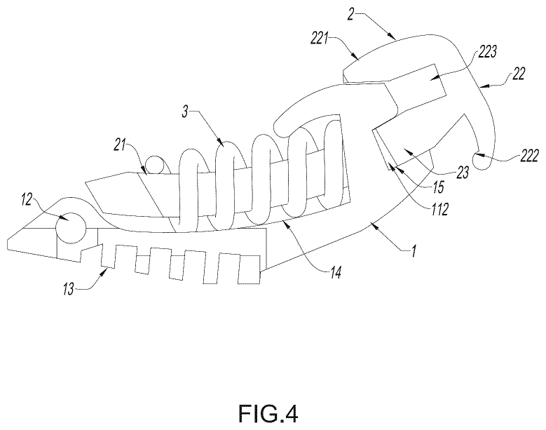

The fixed wing 11 of the bracket base has an arched top and is provided with, in a facing-forward mode, a tying wing 16 with which an end of the spring 3 may be constrained to prevent the bracket wing 2 from disengaging; and the wing portion 22 of the bracket wing is provided with, in a facing-forward mode, a cap 221 that is mated with the arched top, and is provided with, in a facing-downward mode, a tying hook 222, as shown in FIG. 4. On that basis, a square-corner slot 223 accommodating an arch wire is provided between the cap 221 and the wide extension portion 23 to facilitate placement of orthodontics arch wire.

Or, as shown in FIG. 3, the bracket wing is machined to have an arch wire slot 224 at a rear side of the cap 221, and the arch wire slot 224 has front and rear slot faces which are arc faces centered on the auxiliary tube 12. In this way, when the thicknesses of tooth necks are different, individual differences due to the thicknesses can be compensated for by changing the depth by which the arch wire is fed into the groove, while the auxiliary tube is maintained at the same position, so that the distance from the auxiliary tube to the main arch wire is the same distance, reducing bracket errors in clinical caused by differences in teeth.

The dashed lines in FIG. 3 represent concentric arc segments.

What is claimed is:

1. A lingual bracket, comprising a bracket base, a bracket wing, and a spring, the bracket base having an upper surface with an end provided with a fixed wing and the other end provided with an auxiliary tube, and a bottom face provided with a non-skid bonding face; and the bracket wing having an insertion leg and a wing portion, and capable of being positioned on the fixed wing by the spring sleeved on the insertion leg; characterized in that: a longitudinal groove is provided along a central axis of the fixed wing of the bracket base, and a transverse groove is provided at a rear end face of the fixed wing; and the insertion leg of the bracket wing has the width equivalent to that of the longitudinal groove, and is capable of being placed in the longitudinal groove, a joint of the insertion leg and the wing portion is provided with a wide extension part, and when the insertion leg is placed in the longitudinal groove and pushed forward by the spring, the wide extension portion is capable of being interposed into the transverse groove to form a positioning structure.

2. The lingual bracket according to claim 1, characterized in that the upper surface of the bracket base forms a first arc face between the auxiliary tube and the fixed wing, at least a lower surface of the transverse groove of the fixed wing forms a second arc face, and the first arc face and the second arc face share a same center point; the bonding face of the bracket base is biased at an end of the auxiliary tube, and forms a raised arc at an end of the fixed wing; and a mating face of the bracket wing mated with the bracket base also forms an arc face structure that, upon assembling in place, has the same center point as the first arc face.

3. The lingual bracket according to claim 2, characterized in that the second arc face of the surface of the bracket base has a radius smaller than that of the first arc face, and the radius of the second arc face is at least one wire diameter of the spring smaller than that of the first arc face.

4. The lingual bracket according to claim 1, characterized in that the fixed wing of the bracket base has an arched top and is provided with, in a facing-forward mode, a tying wing; and the wing portion of the bracket wing is provided with, in a facing-forward mode, a cap mated with the arched top, and is provided with, in a facing-downward mode, a tying hook.

5. The lingual bracket according to claim 4, characterized in that a square-corner slot accommodating an arch wire is provided between the cap of the bracket wing and the wide extension portion.

6. The lingual bracket according to claim 4, characterized in that the bracket wing is machined to have an arch wire slot at a rear side of the cap, and the arch wire slot has front and rear slot faces which are arc faces centered on the auxiliary tube.

7. The lingual bracket according to claim 2, characterized in that the fixed wing of the bracket base has an arched top and is provided with, in a facing-forward mode, a tying wing; and the wing portion of the bracket wing is provided with, in a facing-forward mode, a cap mated with the arched top, and is provided with, in a facing-downward mode, a tying hook.

8. The lingual bracket according to claim 7, characterized in that a square-corner slot accommodating an arch wire is provided between the cap of the bracket wing and the wide extension portion.

9. The lingual bracket according to claim 7, characterized in that the bracket wing is machined to have an arch wire slot at a rear side of the cap, and the arch wire slot has front and rear slot faces which are arc faces centered on the auxiliary tube.
